(19) United States
(12) Patent Application Publication
(10) Pub. No.: US 2013/0092660 A1
(43) Pub. Date: Apr. 18, 2013

(54) ELECTRIC-DISCHARGE MACHINING CONTROL DEVICE

(71) Applicants: Kazunari Morita, Chiyoda-ku (JP); Hiroki Hikosaka, Chiyoda-ku (JP)

(72) Inventors: Kazunari Morita, Chiyoda-ku (JP); Hiroki Hikosaka, Chiyoda-ku (JP)

(73) Assignee: MITSUBISHI ELECTRIC CORPORATION, Chiyoda-ku, Tokyo (JP)

(21) Appl. No.: 13/805,581

(22) PCT Filed: Jun. 22, 2010
(86) PCT No.: PCT/JP2010/060538

§ 371 Date: Dec. 19, 2012

(30) Foreign Application Priority Data
Jun. 25, 2010 (KR) 10-2010-0060535

(51) Int. Cl. B23H 1/00

(52) U.S. Cl. CPC B23H 1/00
USPC 219/69.11

(57) ABSTRACT

To keep an electric discharge state in an electric-discharge machining device constant, an electric-discharge machining control device includes: a machining power supply that applies a pulsed voltage to a minute gap between an electrode and a workpiece that are arranged to oppose to each other with a predetermined gap therebetween to generate electric discharge; a state amount detector that detects an inter-electrode voltage in the minute gap between the electrode and the workpiece; an electrode-vibration-state detection unit that detects an amplitude of the inter-electrode voltage obtained by the state amount detector; an adjustment-factor setting unit that sets a factor by which an inter-electrode average voltage obtained by the state amount detector is to be multiplied, based on an amplitude of an inter-electrode voltage obtained by the electrode-vibration-state detection unit; and an evaluation-voltage setting unit that sets an evaluation voltage based on the factor outputted from the adjustment-factor setting unit.

### FIELD

The present invention relates to an electric-discharge machining control device that controls an electric-discharge machining device, and more particularly to optimal control of an electric-discharge machining control device that keeps a machining state of an electric-discharge machining device optimal.

### BACKGROUND

An electric-discharge machining device that melt-processes a conductive material such as metal by utilizing a high-temperature energy of electric discharge is well-known. In this electric-discharge machining device, a predetermined voltage is applied between an electrode and a workpiece that are opposed to each other and a pulsed current generated at the time of dielectric breakdown in a minute gap between the electrode and the workpiece is used. In order to maintain the electric discharge by the pulsed current, it is important to adjust the above-mentioned minute gap between the electrode and the workpiece.

Generally, the workpiece is melted and removed by the high-temperature energy of the electric discharge generated in the gap between the electrode and the workpiece. When a distance between the electrode and the workpiece is fixed, as machining proceeds, an inter-electrode gap is extended and a state proceeds to a state where the electric discharge hardly occurs. When extension of the inter-electrode gap proceeds to a distance in which the electric discharge can not be maintained, machining stops. In order to prevent such a situation, control is made to maintain the inter-electrode gap to be optimal generally in electric discharge machining.

Machining dusts generated in a gap between electrodes during machining are generally washed away by an insulative machining fluid or the like. However, when the machining fluid cannot be sufficiently supplied to an electric discharge position or when the inter-electrode gap is small, the machining dusts may locally reduce insulation of the inter-electrode gap, resulting in an electrically conductive state. In this case, a voltage sufficient for generating electric discharge may not be applied to the gap, and thus the electric discharge may be stopped or an excessive current locally may flow to damage the electrode and the workpiece. For such a case, by expanding the inter-electrode gap, an insulation state is recovered or a flow path of the machining fluid is ensured.

In short, in the electric discharge machining, by executing control of continuously narrowing and expanding the inter-electrode gap, an averagely optimal distance is maintained. This ability of controlling the inter-electrode gap is a basic capability that greatly influences on the machining result of the electrode and the workpiece.

In this way, controlling and maintaining the inter-electrode gap are basic and important control contents in the electric discharge machining. However, it is not easy to directly measure the inter-electrode gap during electric discharge and is impossible in practice.

For this reason, generally by detecting a state amount for a distance between electrodes that can be regarded as equivalent to the inter-electrode distance, the inter-electrode gap is estimated and compared to an arbitrarily set state amount in terms of magnitude, so as to execute the control (see, for example, Patent Literatures 1 to 3).

FIG. 8 is a block diagram of a conventional electric-discharge machining control device described in, for example, Patent Literature 3. FIG. 9 is an electrical circuit diagram of one example in a case of configuring the contents explained in the block diagram of FIG. 8 as an actual electrical circuit. In a conventional electric-discharge machining control device 201, an inter-electrode average voltage 9 obtained from a state amount (an inter-electrode voltage waveform) 7 is used for estimating an inter-electrode gap. This method has been conventionally performed and it is called “average-voltage servo system”. The inter-electrode average voltage 9 is proportional to the inter-electrode gap. By executing control to narrow the inter-electrode gap so as to easily generate electric discharge when the average voltage is higher than an inter-electrode set voltage 1 to be targeted and expand the inter-electrode gap so as to suppress the electric discharge when the average voltage is lower than the inter-electrode set voltage 1, a satisfied electric discharge state is maintained.

Here, there is an attempt to consider the case where a drive device is operated to feed an electrode to keep the inter-electrode gap constant, in the situation that disturbance caused by a machining speed 5 enters this system and the inter-electrode gap is expanded.

The fact that the inter-electrode gap is expanded by machining appears as a fact of electric discharge hardly occurring in the inter-electrode voltage waveform through an inter-electrode phenomenon 6. When the electric discharge hardly occurs, the inter-electrode average voltage 9 is increased. A comparator 2 detects an error amount 10 representing a difference between the inter-electrode average voltage 9 and the inter-electrode set voltage 1. This error amount 10 is multiplied by a proportional gain 3 and the product is sent as a speed command 11 for driving a servomechanism 4. When the servomechanism 4 feeds the electrode by a distance by which the inter-electrode distance is expanded by machining, the inter-electrode gap becomes the original distance suitable for electric discharge, the inter-electrode average voltage becomes the voltage 9 and matches the inter-electrode set voltage 1 again.

For example, when the proportional gain 3 is set to an excessively large value, a response phase difference between a drive signal sent from the proportional gain 3 to the servomechanism 4 and a mechanical structure and a servomechanism or the like becomes larger, the drive device is operated by a distance equal to or longer than the inter-electrode gap expanded by machining, so that the inter-electrode gap is narrowed conversely. In this case, the inter-electrode average voltage becomes lower conversely and a signal for expanding the inter-electrode gap is sent to the servomechanism 4, so that the inter-electrode gap tends to be expanded again. However, the inter-electrode average voltage 9 and the servomechanism 4 become in an oscillation state, and depending on circumstances, fall in a hunting state where a short-circuit state and a release state are repeated in the inter-electrode gap. Conversely, when the proportional gain 3 is too small, a delay time required for recovering the system becomes larger, it is not possible to respond to disturbance entering the system as the machining speed 5 at a sufficiently high speed, and setting an idealistic space becomes difficult, thereby causing problems including decrease in machining speed.

As explained above, the proportional gain 3 needs to be set to an optimal value. FIG. 9 shows one example in the case of configuring the contents explained in the block diagram of FIG. 8 as an actual electrical circuit. Components denoted by the same reference signs as those in FIG. 8 represent equivalent contents to those in the latter. Low-pass filters 8a and 8b constitute an inter-electrode voltage detection unit 8B and output the inter-electrode average voltage 9. In addition, FIG. 9 depicts constituent elements generally included for an electric-discharge machining device. That is, the electric-discharge machining device includes a machining power supply 18 for supplying an electric discharge energy, a resistor 17 for specifying an electric discharge energy as a current value, a switching element 19 for forming a pulsed current waveform, an oscillator 20 for the switching, an electrode 23, a workpiece 24, a work tank 21, and a machining fluid 22.

### CITATION LIST

### Patent Literatures

Patent Literature 1: Japanese Patent Application Laid-open No. 63-312020
Patent Literature 2: Japanese Patent Application Laid-open No. 1-301019
Patent Literature 3: Japanese Patent Application Laid-open No. 2-036018

### SUMMARY

### Technical Problem

However, in such electric discharge machining, unless control is always executed against disturbances such as the course of machining and generation of machining dusts and an inter-electrode gap suitable for electric discharge is maintained, efficient machining can not be expected. To this end, a proportional gain for a servomechanism that changes the inter-electrode gap needs to be set optimally.

However, in electric discharge machining, an optimal value of a proportional gain is not determined merely by the mechanical rigidity and characteristics of the servomechanism but is changed time to time depending on the machining contents and machining conditions. Therefore, it is difficult for an operator to manually set the proportional gain to an optimal value over the entire period of time during machining.

The present invention has been achieved in view of the above-mentioned circumstances, and an object of the present invention is to provide an electric-discharge machining control device in which the optimization is realized by determining an inter-electrode state based on electrical signal information of an inter-electrode voltage such as an amplitude of the inter-electrode voltage or a frequency of the inter-electrode voltage at the time of short-circuiting and automatically setting a factor of evaluation voltage data by which a proportional gain is to be multiplied, change of a state during machining can be flexibly handled, and optimal electric discharge machining is performed in an unattended manner without depending on the experience of an operator.

### Solution to Problem

In order to solve the above-mentioned problems and achieve the object, one aspect of the present invention provides a control device for an electric-discharge machining device, which controls an electric-discharge machining device that applies a voltage to a minute gap between an electrode and a workpiece that are arranged to oppose to each other with a predetermined gap therebetween to generate electric discharge and performs machining utilizing a high-temperature energy of the electric discharge, with a speed command value of a servomechanism that drives the electrode being provided by multiplying a difference between a target voltage and an evaluation voltage by a proportional gain, the control device comprising: a machining power supply that applies a pulsed voltage to the minute gap; a state amount detector that detects an inter-electrode voltage in a minute gap between the electrode and the workpiece; an electrode-vibration-state detection unit that detects an amplitude of the inter-electrode voltage obtained by the state amount detector; an adjustment-factor setting unit that sets a factor by which an inter-electrode average voltage obtained by the state amount detector is to be multiplied, based on an amplitude of an inter-electrode voltage obtained by the electrode-vibration-state detection unit; and an evaluation-voltage setting unit that sets an evaluation voltage based on a factor outputted from the adjustment-factor setting unit.

Another aspect of the present invention provides a control device for an electric-discharge machining device, which controls an electric-discharge machining device that applies a voltage to a minute gap between an electrode and a workpiece that are arranged to oppose to each other with a predetermined gap therebetween to generate electric discharge and performs machining utilizing a high-temperature energy of the electric discharge, with a speed command value of a servomechanism that drives the electrode being provided by multiplying a difference between a target voltage and an evaluation voltage by a proportional gain, the control device comprising: a machining power supply that applies a pulsed voltage to the minute gap; a state amount detector that detects an inter-electrode voltage in a minute gap between the electrode and the workpiece; an electrode-vibration-state detection unit that detects a frequency of an inter-electrode voltage obtained by the state amount detector at the time of short-circuiting; an adjustment-factor setting unit that sets a factor by which an inter-electrode average voltage obtained by the state amount detector is to be multiplied, based on the frequency of the inter-electrode voltage obtained by the electrode-vibration-state detection unit at the time of short-circuiting; and an evaluation-voltage setting unit that sets an evaluation voltage based on a factor outputted from the adjustment-factor setting unit.

A further aspect of the present invention provides a control device for an electric-discharge machining device, which controls an electric-discharge machining device that applies a voltage to a minute gap between an electrode and a workpiece that are arranged to oppose to each other with a predetermined gap therebetween to generate electric discharge and performs machining utilizing a high-temperature energy of the electric discharge, with a speed command value of a servomechanism that drives the electrode being provided by multiplying a difference between a target voltage and an evaluation voltage by a proportional gain, the control device comprising: a machining power supply that applies a pulsed voltage to the minute gap; a state amount detector that detects an inter-electrode voltage in a minute gap between the electrode and the workpiece; an adjustment-factor setting unit that sets a factor by which an inter-electrode average voltage obtained by the state amount detector, is to be multiplied, based on a feedback amount; and an evaluation-voltage setting unit that sets an evaluation voltage based on the factor outputted from the adjustment-factor setting unit.

### Advantageous Effects of Invention

According to the electric-discharge machining control device of the present invention, an amplitude of an inter-electrode voltage, a frequency of an inter-electrode voltage at the time of short-circuiting, or an amplitude of a position feedback amount of a servo system is detected and an evaluation voltage is changed based on the detection result. Therefore, it is possible, as advantageous effects, to inexpensively realize an electric-discharge machining control device that can always perform machining with an optimal machining gain against variations in weight of a used electrode, machining area, machining shape, machining speed and machining current.

### BRIEF DESCRIPTION OF DRAWINGS

FIG. 1 is a diagram showing an electric-discharge machining control device according to a first embodiment of an electric-discharge machining control device according to the present invention.

FIG. 2 is a parameter table figure representing a relationship between inter-electrode voltage amplitudes and factors corresponding thereto, which is used when an adjustment-factor setting unit sets the factor.

FIG. 3 is a diagram showing an electric-discharge machining control device according to a second embodiment of the electric-discharge machining control device according to the present invention.

FIG. 4 is a parameter table figure representing a relationship between inter-electrode voltage frequencies and factors corresponding thereto, which is used when an adjustment-factor setting unit sets the factor.

FIG. 5 is a diagram showing an electric-discharge machining control device according to a third embodiment of the electric-discharge machining control device according to the present invention.

FIG. 6 is a diagram showing an electric-discharge machining control device according to a fourth embodiment of the electric-discharge machining control device according to the present invention.

FIG. 7 is a parameter table figure representing a relationship between amplitudes of a position feedback amount and factors corresponding thereto, which is used when an adjustment-factor setting unit sets the factor.

FIG. 8 is a block diagram of a conventional electric-discharge machining control device.

FIG. 9 is a diagram showing one example in a case of configuring contents explained in the block diagram of FIG. 8 as an actual electrical circuit.

### DESCRIPTION OF EMBODIMENTS

Embodiments of an electric-discharge machining control device according to the present invention will be described below in detail with reference to the drawings. The present invention is not limited to these embodiments.

### First Embodiment

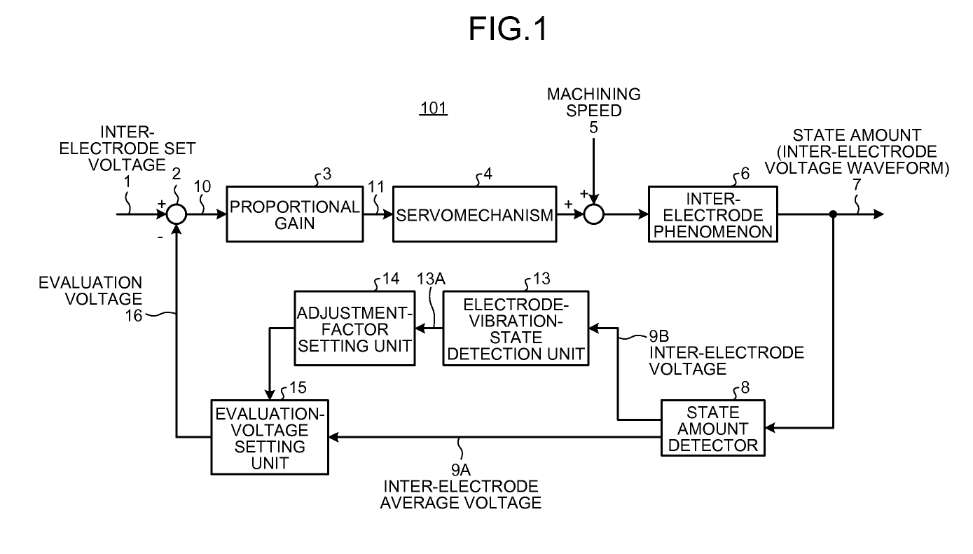

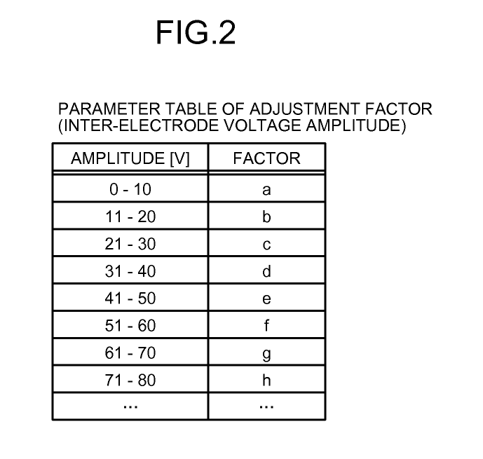

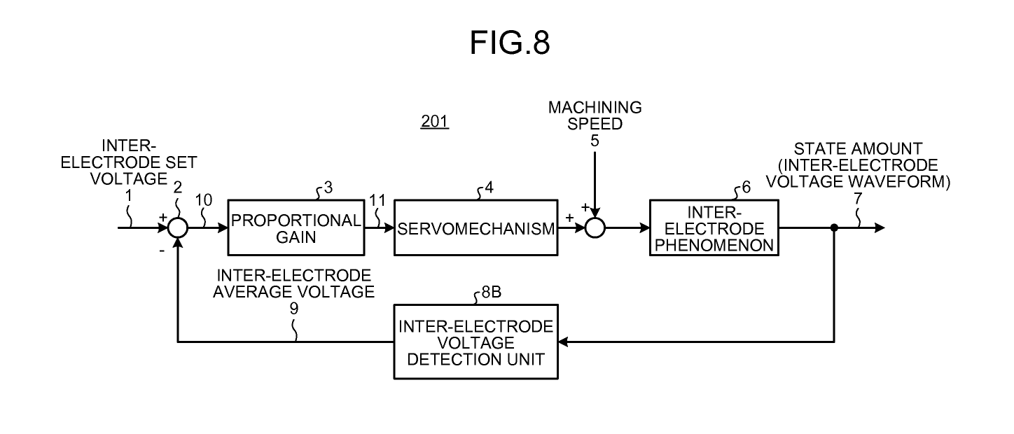

FIG. 1 is a diagram showing an electric-discharge machining control device according to a first embodiment of the electric-discharge machining control device according to the present invention. FIG. 2 is a parameter table figure representing a relationship between inter-electrode voltage amplitudes and factors corresponding thereto, which is used when an adjustment-factor setting unit sets the factor. An electric-discharge machining control device 101 according to the present embodiment includes, as shown in FIG. 1, the comparator 2, the proportional gain 3, the servomechanism 4, a state amount detector 8, an electrode-vibration-state detection unit 13, an adjustment-factor setting unit 14, and an evaluation-voltage setting unit 15. The comparator 2, the proportional gain 3 and the servomechanism 4 are the same as those of the conventional electric-discharge machining control device 201 shown in FIG. 8.

An electric-discharge machining device applies a voltage to a minute gap between the electrode 23 and the workpiece 24 arranged to oppose to each other with a predetermined space therebetween to generate electric discharge (FIG. 8) and performs machining utilizing a high-temperature energy of the electric discharge. The electric-discharge machining control device 101 controls such an electric-discharge machining device with the speed command value 11 of the servomechanism 4 that drives the electrode 23 being obtained by multiplying a difference between an inter-electrode set voltage (target voltage) and an evaluation voltage 16 by the proportional gain 3.

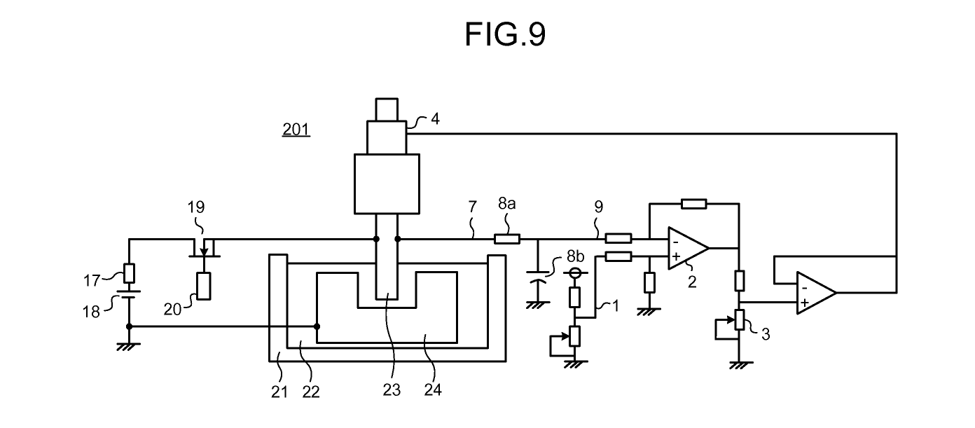

Furthermore, as compared to the conventional electric-discharge machining control device 201, the electric-discharge machining control device 101 according to the present embodiment includes, as shown in FIG. 1, the following components instead of the inter-electrode voltage detection unit 8B. That is, the electric-discharge machining control device 101 includes the state amount detector 8 that detects an inter-electrode voltage in the minute gap between the electrode 23 and the workpiece 24, the electrode-vibration-state detection unit 13 that detects an amplitude of the inter-electrode voltage obtained by the state amount detector 8, the adjustment-factor setting unit 14 that sets a factor by which an inter-electrode average voltage 9A obtained by the state amount detector 8 is to be multiplied based on the amplitude of the inter-electrode voltage obtained by the electrode-vibration-state detection unit 13, and the evaluation-voltage setting unit 15 that sets the evaluation voltage 16 based on the factor outputted from the adjustment-factor setting unit 14. Other configuration including the part shown by the electrical circuit in FIG. 9 is the same as that of the conventional electric-discharge machining control device 201. The state amount detector 8 is configured to include low-pass filters as with the inter-electrode voltage detection unit 8B (low-pass filters 8a and 8b) shown in FIG. 8.

In the electric-discharge machining control device 101 according to the present embodiment, the state amount detector 8 detects the inter-electrode voltage in a minute gap between an electrode of the electric-discharge machining device and a workpiece. The state amount detector 8 then outputs the inter-electrode average voltage 9A to the evaluation-voltage setting unit 15 and an inter-electrode voltage 9B to the evaluation-voltage setting unit 15. The electrode-vibration-state detection unit 13 detects an amplitude 13A of the inter-electrode voltage obtained by the state amount detector 8.

The electrode-vibration-state detection unit 13 has a storage device (not shown) that stores therein the inter-electrode voltage 9B outputted from the state amount detector 8 and detects the amplitude 13A of the inter-electrode voltage from the inter-electrode voltage 9B stored in the storage device in a time-oriented manner.

In the following, operations of the electric-discharge machining control device 101 according to the present embodiment is explained. First, an inter-electrode gap is set to be optimal and a pulsed voltage is applied from the machining power supply 18 to a gap between electrodes. As electric discharge machining proceeds, the position of a machined surface is changed. The state amount detector 8 detects the state amount (the inter-electrode voltage waveform) 7 that changes according to change in the inter-electrode gap. The amplitude of the inter-electrode voltage of the state amount (the inter-electrode voltage waveform) 7 mentioned above is then measured by the electrode-vibration-state detection unit 13, a value is selected in the adjustment-factor setting unit 14 from a parameter table of factors set in advance as shown in FIG. 2 based on the amplitude of the voltage set in the electrode-vibration-state detection unit 13, and an adjustment factor is determined. The determined adjustment factor is multiplied by the inter-electrode average voltage 9A outputted from the state amount detector 8 described above, so as to make the product an evaluation voltage 16. A difference between the evaluation voltage 16 and the inter-electrode set voltage (target voltage) 1 is multiplied by the proportional gain 3 and the product is outputted as the speed command value 11 to the servomechanism 4. The servomechanism 4 executes control so that a position or speed of the electrode matches a command value based on the speed command value 11.

As explained above, according to the electric-discharge machining control device 101 of the present embodiment, the electrode-vibration-state detection unit 13 detects the amplitude of the inter-electrode voltage 9B by the state amount detector 8 to detect a vibration state of the gap between electrodes, so as to change the evaluation voltage 16. Accordingly, it is possible to inexpensively realize an electric-discharge machining device that can always perform machining with an optimal machining gain against variations in weight of a used electrode, machining area, machining shape, machining speed, machining current or the like.

In the parameter table shown in FIG. 2, reference values are set in advance for each model of electric-discharge machining device by a test or the like. When a product is shipped and then the electric-discharge machining device is installed at an installation site, the values are adjusted anew. The factor is an approximate proportional value that is increased as the amplitude is increased.

### Second Embodiment

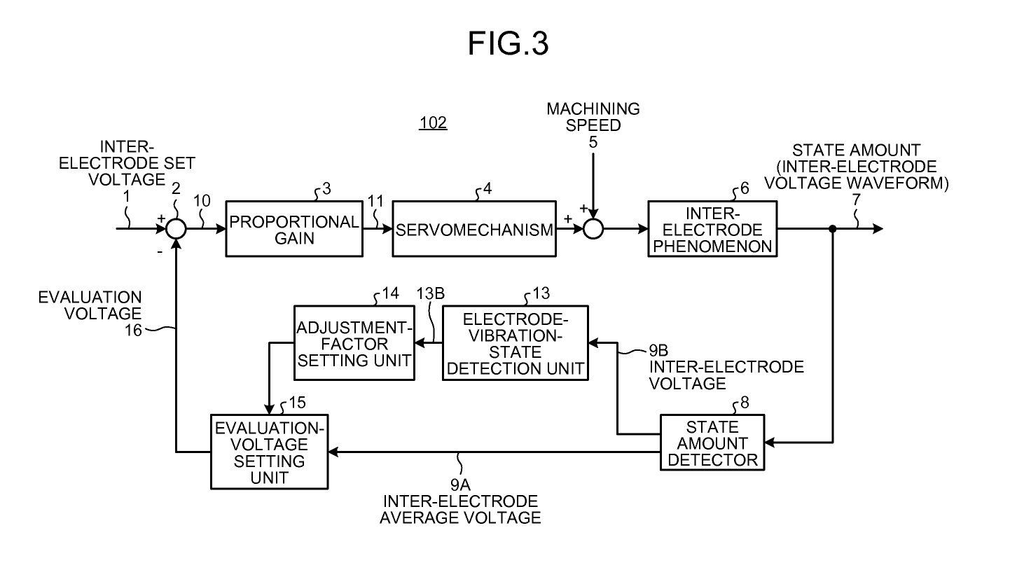

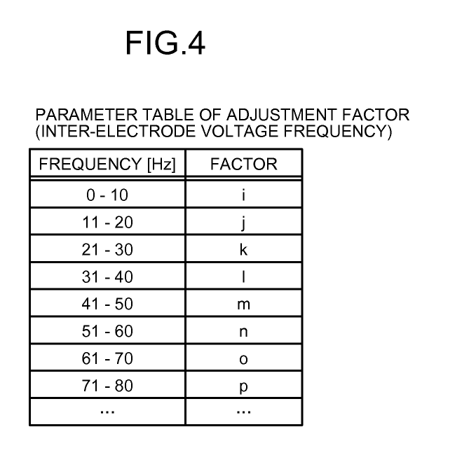

FIG. 3 is a diagram showing an electric-discharge machining control device according to a second embodiment of the electric-discharge machining control device according to the present invention. FIG. 4 is a parameter table figure representing a relationship between inter-electrode voltage frequencies and factors corresponding thereto, which is used when an adjustment-factor setting unit sets the factor. In an electric-discharge machining control device 102 according to the present embodiment, the electrode-vibration-state detection unit 13 detects a frequency 13B of the inter-electrode voltage 9B obtained by the state amount detector 8 at the time of short-circuiting. The adjustment-factor setting unit 14 sets a factor by which the inter-electrode average voltage 9A obtained by the state amount detector 8 is to be multiplied, from the parameter table of FIG. 4 based on the frequency 13B of the inter-electrode voltage obtained by the electrode-vibration-state detection unit 13. The evaluation-voltage setting unit 15 sets the evaluation voltage 16 based on the factor outputted from the adjustment-factor setting unit 14. Other configurations of the second embodiment are identical to those of the first embodiment.

The electrode-vibration-state detection unit 13 has a storage device (not shown) that stores therein the inter-electrode voltage 9B outputted from the state amount detector 8 and detects the frequency 13B of the inter-electrode voltage at the time of short-circuiting from the inter-electrode voltage 9B stored in the storage device in a time-oriented manner.

In the parameter table shown in FIG. 4, reference values are set in advance for each model of electric-discharge machining device by a test or the like. When a product is shipped and then the electric-discharge machining device is installed at an installation site, the values are adjusted anew. The factor is an approximate inverse-proportional value that is reduced increased as the frequency of the inter-electrode voltage is increased.

### Third Embodiment

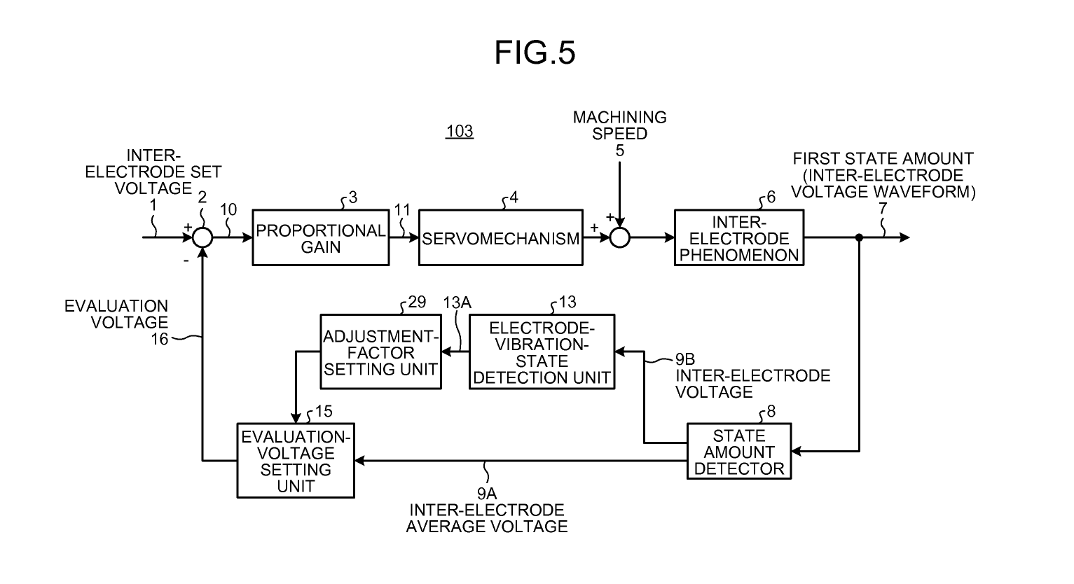

FIG. 5 is a diagram showing an electric-discharge machining control device according to a third embodiment of the electric-discharge machining control device according to the present invention. An adjustment-factor setting unit 29 of an electric-discharge machining control device 103 according to the present embodiment calculates a factor using a formula instead of such a parameter table as shown in FIG. 2. The factor is in an approximate proportional relationship that as the inter-electrode voltage amplitude is increased, its value is increased as explained above. Therefore, an approximate value of the factor can be obtained from a predetermined formula. Other configurations of the third embodiment are identical to those of the first embodiment.

It is noted that the present embodiment may be applied to the second embodiment and the factor may be calculated from the frequency of the inter-electrode voltage using the predetermined formula instead of the parameter table. As explained above, because the factor is in an approximate inverse-proportional relationship that as the frequency of the inter-electrode voltage is increased, its value is increased. Therefore, an approximate value of the factor can be obtained from the predetermined formula. According to the present embodiment, finer optimization control can be realized as compared to a parameter-table parameter system of the first or second embodiment.

### Fourth Embodiment

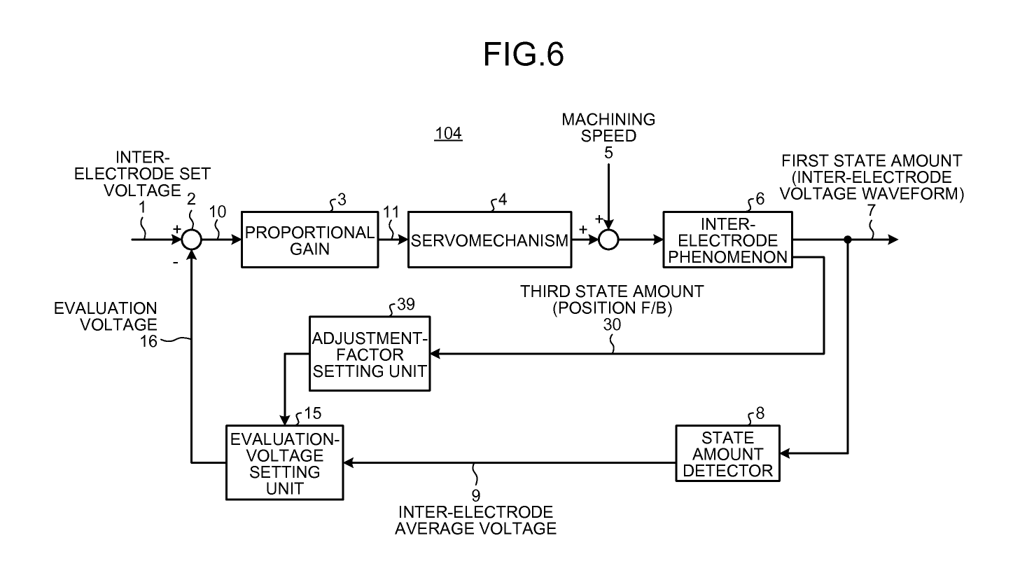

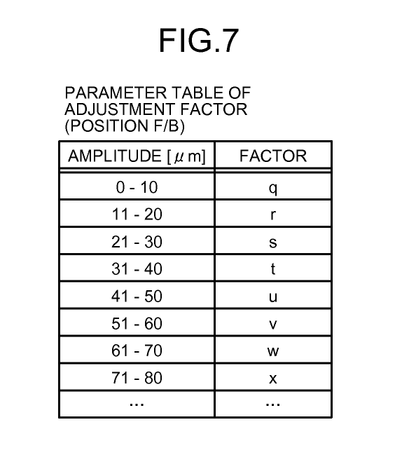

FIG. 6 is a diagram showing an electric-discharge machining control device according to a fourth embodiment of the electric-discharge machining control device according to the present invention. FIG. 7 is a parameter table figure representing a relationship between amplitudes of a position feedback amount and factors corresponding thereto, which is used when an adjustment-factor setting unit sets the factor. An electric-discharge machining control device 104 according to the present embodiment includes the state amount detector 8, an adjustment-factor setting unit 39, and the evaluation-voltage setting unit 15. The state amount detector 8 detects the inter-electrode voltage in a minute gap between an electrode and a workpiece in an electric-discharge machining device. The state amount detector 8 then outputs the inter-electrode average voltage 9 to the evaluation-voltage setting unit 15. The adjustment-factor setting unit 39 receives a position feedback amount 30 serving as a third state amount obtained from the inter-electrode gap phenomenon 6, calculates its amplitude, and selects a factor from the parameter table shown in FIG. 7. This factor is used as a multiplier by which the inter-electrode average voltage 9 obtained by the state amount detector 8 is multiplied, by the evaluation-voltage setting unit 15. The evaluation-voltage setting unit 15 sets an evaluation voltage based on the factor outputted from the adjustment-factor setting unit 39. Other configurations of the fourth embodiment are identical to those of the first embodiment.

According to the present embodiment, the control can be easily realized even in software. So, when there is no problem in a case where the frequency of optimization is about a communication frequency of a servo system, it is possible to inexpensively realize an electric-discharge machining device that can always perform machining with an optimal machining gain against disturbance elements such as the machining contents and machining conditions.

As explained above, according to the electric-discharge machining control devices of the first to fourth embodiments, an amplitude of an inter-electrode voltage, a frequency of an inter-electrode voltage at the time of short-circuiting, or an amplitude of a position feedback amount of a servo system is detected and an evaluation voltage is changed based on the detection result. Accordingly, it is possible to inexpensively realize an electric-discharge machining device that can always perform machining with an optimal machining gain against variations in weight of a used electrode, machining area, machining shape, machining speed, machining current or the like.

### INDUSTRIAL APPLICABILITY

As described above, the electric-discharge machining control device according to the present invention is suitable for an electric-discharge machining device that applies a predetermined voltage between an electrode and a workpiece to generate a pulsed current in a minute gap between the electrode and the workpiece and performs melt processing utilizing a high-temperature energy of electric discharge.

### REFERENCE SIGNS LIST

1 inter-electrode set voltage (target voltage)
2 comparator
3 proportional gain
4 servomechanism
5 machining speed
6 inter-electrode phenomenon
7 state amount (inter-electrode voltage waveform)
8 state amount detector
8B inter-electrode voltage detection unit
8a, 8b low-pass filter
9, 9A inter-electrode average voltage
9B inter-electrode voltage
10 error amount (difference)
11 speed command value
13 electrode-vibration-state detection unit
13A amplitude of inter-electrode voltage
13B frequency of inter-electrode voltage at the time of short-circuiting
14, 29, 39 adjustment-factor setting unit
15 evaluation-voltage setting unit
16 evaluation voltage
17 resistor
18 machining power supply
19 switching element
20 oscillator
21 work tank
22 machining fluid
23 electrode
24 workpiece
101, 102, 103, 104, 201 electric-discharge machining control device

1. A control device for an electric-discharge machining device, which controls an electric-discharge machining device that applies a voltage to a minute gap between an electrode and a workpiece that are arranged to oppose to each other with a predetermined gap therebetween to generate electric discharge and performs machining utilizing a high-temperature energy of the electric discharge, with a speed command value of a servomechanism that drives the electrode being provided by multiplying a difference between a target voltage and an evaluation voltage by a proportional gain, the control device comprising:
a machining power supply that applies a pulsed voltage to the minute gap;
a state amount detector that detects an inter-electrode voltage in a minute gap between the electrode and the workpiece;
an electrode-vibration-state detection unit that detects an amplitude of the inter-electrode voltage obtained by the state amount detector;
an adjustment-factor setting unit that sets a factor by which an inter-electrode average voltage obtained by the state amount detector is to be multiplied, based on an amplitude of an inter-electrode voltage obtained by the electrode-vibration-state detection unit; and
an evaluation-voltage setting unit that sets an evaluation voltage based on a factor outputted from the adjustment-factor setting unit.

2. A control device for an electric-discharge machining device, which controls an electric-discharge machining device that applies a voltage to a minute gap between an electrode and a workpiece that are arranged to oppose to each other with a predetermined gap therebetween to generate electric discharge and performs machining utilizing a high-temperature energy of the electric discharge, with a speed command value of a servomechanism that drives the electrode being provided by multiplying a difference between a target voltage and an evaluation voltage by a proportional gain, the control device comprising:
a machining power supply that applies a pulsed voltage to the minute gap;
a state amount detector that detects an inter-electrode voltage in a minute gap between the electrode and the workpiece;
an electrode-vibration-state detection unit that detects a frequency of an inter-electrode voltage obtained by the state amount detector at the time of short-circuiting;
an adjustment-factor setting unit that sets a factor by which an inter-electrode average voltage obtained by the state amount detector is to be multiplied, based on the frequency of the inter-electrode voltage obtained by the electrode-vibration-state detection unit at the time of short-circuiting; and
an evaluation-voltage setting unit that sets an evaluation voltage based on a factor outputted from the adjustment-factor setting unit.

3. A control device for an electric-discharge machining device, which controls an electric-discharge machining device that applies a voltage to a minute gap between an electrode and a workpiece that are arranged to oppose to each other with a predetermined gap therebetween to generate electric discharge and performs machining utilizing a high-temperature energy of the electric discharge, with a speed command value of a servomechanism that drives the electrode being provided by multiplying a difference between a target voltage and an evaluation voltage by a proportional gain, the control device comprising:
a machining power supply that applies a pulsed voltage to the minute gap;
a state amount detector that detects an inter-electrode voltage in a minute gap between the electrode and the workpiece;
an adjustment-factor setting unit that sets a factor by which an inter-electrode average voltage obtained by the state amount detector, is to be multiplied, based on a feedback amount; and
an evaluation-voltage setting unit that sets an evaluation voltage based on the factor outputted from the adjustment-factor setting unit.

4. The electric-discharge machining control device according to claim 3, wherein the feedback amount is a position feedback amount.

5. The electric-discharge machining control device according to claim 3, wherein the adjustment-factor setting unit selects a factor by which the inter-electrode average voltage is to be multiplied, based on a parameter table set in advance.

6. The electric-discharge machining control device according to claim 3, wherein the adjustment-factor setting unit selects a factor by which the inter-electrode average voltage is to be multiplied, using a formula for calculating an approximate value of a factor.

7. The electric-discharge machining control device according to claim 3, wherein the state amount detector is configured to include a low-pass filter.

8. The electric-discharge machining control device according to claim 1, wherein the electrode-vibration-state detection unit includes a storage unit that stores therein amplitudes of an inter-electrode voltage in a time-oriented manner.

9. The electric-discharge machining control device according to claim 2, wherein the electrode-vibration-state detection unit includes a storage unit that stores therein frequencies of an inter-electrode voltage at the time of short-circuiting in a time-oriented manner.

10. The electric-discharge machining control device according to claim 1, wherein the adjustment-factor setting unit selects a factor by which the inter-electrode average voltage is to be multiplied, based on a parameter table set in advance.

11. The electric-discharge machining control device according to claim 1, wherein the adjustment-factor setting unit selects a factor by which the inter-electrode average voltage is to be multiplied, using a formula for calculating an approximate value of a factor.

12. The electric-discharge machining control device according to claim 1, wherein the state amount detector is configured to include a low-pass filter.

13. The electric-discharge machining control device according to claim 2, wherein the adjustment-factor setting unit selects a factor by which the inter-electrode average voltage is to be multiplied, based on a parameter table set in advance.

14. The electric-discharge machining control device according to claim 2, wherein the adjustment-factor setting unit selects a factor by which the inter-electrode average voltage is to be multiplied, using a formula for calculating an approximate value of a factor.

15. The electric-discharge machining control device according to claim 2, wherein the state amount detector is configured to include a low-pass filter.
